(19) United States
(12) Patent Application Publication
(10) Pub. No.: US 2012/0158894 A1
(43) Pub. Date: Jun. 21, 2012

(54) VIDEO STREAM DISTRIBUTION

(76) Inventors: Yves Desgagné, Blainville (CA); Guillermo Gonzalez, Longueuil (CA)

(21) Appl. No.: 13/232,526

(22) Filed: Sep. 14, 2011

Related U.S. Application Data
(60) Provisional application No. 61/425,637, filed on Dec. 21, 2010.
(60) Provisional application No. 61/432,667, filed on Jan. 14, 2011.

(51) Int. Cl. G06F 15/16

(52) U.S. Cl. 709/217

(57) ABSTRACT

A method of operating a video system to distribute video streams includes receiving at least one video stream at a primary video management system, receiving the video stream at a primary media gateway, receiving a request for access to the video stream from a secondary video management system, and transmitting the video stream for delivery from the primary media gateway to the secondary video management system.

### RELATED APPLICATIONS

This application claims the benefit of U.S. Provisional Application Ser. No. 61/425,637 filed Dec. 21, 2010 entitled “VIDEO STREAM DISTRIBUTION” and U.S. Provisional Application Ser. No. 61/432,667 filed Jan. 14, 2011 entitled “VIDEO STREAM DISTRIBUTION,” both of which are hereby incorporated by reference in their entireties.

### TECHNICAL BACKGROUND

Many common video systems include video cameras and video management systems. The video management system receives and processes streams of video or images which are captured by the video cameras. Many of these video systems process and store video in digital form. The video management system may also control the video cameras by sending pan, tilt, zoom, or other instructions.

Video systems are often used for surveillance or security applications. In these applications, many video cameras may be used. A user may not be able to view all of the video streams simultaneously and must choose or indicate which video streams are of interest for viewing at a particular time. The system components which enable the video system to perform these functions are often located at one physical site or within one computer network. In some cases, a second party may also wish to have access to some or all of the video streams. The video management system used by the second party may reside in a different network, in a different physical location, or both.

### OVERVIEW

In at least one example, a method of operating a video system to distribute video streams includes receiving at least one video stream at a primary video management system, receiving the video stream at a primary media gateway, receiving a request for access to the video stream from a secondary video management system, and transmitting the video stream for delivery from the primary media gateway to the secondary video management system.

In another example, a video system, includes at least one video source, a primary video management system configured to receive a video stream captured by the video source, a primary media gateway configured to receive the video stream, and a secondary video management system configured to generate a request for access to the video stream. The primary media gateway is configured to transmit the video stream for delivery from the primary media gateway to the secondary video management system.

In an embodiment, receiving the video stream at the primary video management system and receiving the video stream at the primary media gateway occur simultaneously.

In an embodiment, the video stream received at the primary media gateway is transmitted from the primary video management system to the primary media gateway.

In an embodiment, the video management system further transmits the video stream to a viewing and control client.

In an embodiment, a method includes transmitting the video stream from the secondary video management system to a secondary viewing and control client.

In an embodiment, a method further comprises establishing authorizations for access to the video stream through the primary media gateway, determining if the secondary video management system is authorized to access the video stream based on the authorizations, and responsive to a determination that the secondary video management system is authorized, transmitting the video stream for delivery from the primary media gateway to the secondary video management system.

In an embodiment, the video stream is transmitted over a network.

In an embodiment, the video stream is transmitted over a virtual private network.

In an embodiment, the request includes a uniform resource locator associated with the video stream.

In an embodiment, the primary video management system has primary control over a video source associated with the video stream and wherein the primary media gateway grants secondary control over the video sources associated with the video stream to the secondary video management system based on the request for access to the video stream, the secondary control being subordinate to the primary control.

### BRIEF DESCRIPTION OF THE DRAWINGS

FIG. 1 illustrates a video system;

FIG. 2 illustrates operation of a video system;

FIG. 3 illustrates a video system;

FIG. 4 illustrates operation of a video system;

FIG. 5 illustrates a video system;

FIG. 6 illustrates a media gateway.

### DETAILED DESCRIPTION

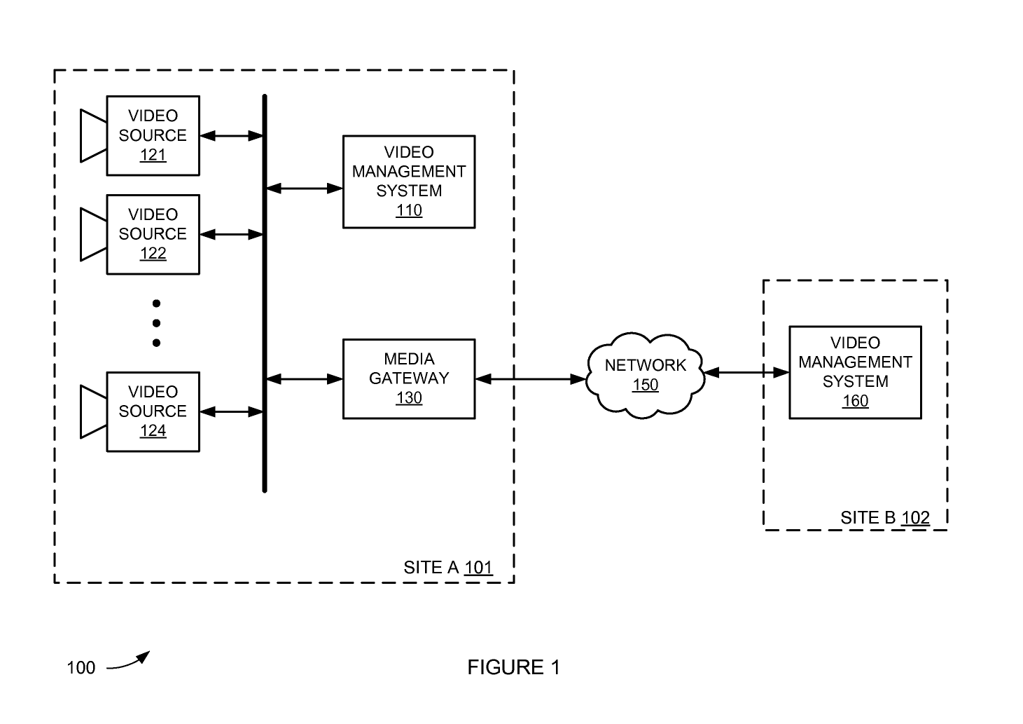

FIGS. 1-6 and the following description depict specific embodiments of the invention to teach those skilled in the art how to make and use the best mode of the invention. For the purpose of teaching inventive principles, some conventional aspects have been simplified or omitted. Those skilled in the art will appreciate variations from these embodiments that fall within the scope of the invention. Those skilled in the art will appreciate that the features described below can be combined in various ways to form multiple embodiments and variations of the invention. As a result, the invention is not limited to the specific embodiments described below, but only by the claims and their equivalents.

Video systems used for security or surveillance purposes often use one or more video sources to capture video of one or more scenes for purposes of monitoring people, objects, vehicles, or activities in those scenes. Some of the video may be viewed in real time and some of the video may also be stored for viewing at a later time if so desired. These video system installations typically have many cameras and a user often selects which video stream he/she is interested in viewing at the time. A user typically has access to multiple streams of video and performs video stream viewing activities through use of a video management system (VMS). Among many other functions, the VMS may also be used to perform control functions on the video sources including pan, tilt, zoom, power cycling, as well as other functions.

In some cases, a second party may also wish to receive or view video streams from one or more of the video sources, also through use of a VMS. The second party may wish to view video streams concurrently with the first party but may also wish to view different subsets of the many video streams. The VMS used by the second party may be on a different network than the other components of the video system, may be at a different physical location, or both.

One example of this situation is a public area which is under the authority of two different law enforcement organizations. The first law enforcement organization may be the primary operator of the surveillance system but may wish to give the second law enforcement organization access to some or all of the video streams. Although post-incident video review and analysis may be useful, there may also be a desire for the second law enforcement organization to be able to select, receive, and view video streams in real time, or near real time.

Another example is the corporate headquarters of a business which monitors security video streams of a remote site. The surveillance system is implemented at the remote site within the network of the remote site. Local personnel at the remote site manage the surveillance system and monitor video streams using a local VMS. However, the corporate headquarters may also want the option of remotely accessing and monitoring video streams from the surveillance system using a second VMS. The corporate headquarters may wish to do this over an open network because there is no internal network or dedicated link between the two sites.

In another variation, a business entity may be performing an activity which is subject to supervision or some sort of regulatory control. A private party or government agency may be given access to video streams of the activity in order to perform this supervisory or regulatory function. The VMS used by the supervisory party may be located outside of the network where video is being captured and initially processed. Access to the video streams may have to be obtained through an Internet connection or some other type of publicly accessible network connection.

FIG. 1 illustrates video system 100. Video system 100 is spread across two physical locations, site A 101 and site B 102. At site A 101, video system 100 includes video sources 121-124, video management system 110 (hereinafter referred to as VMS 110), and media gateway 130. The components located at site A 101 may be described as being primary components. Further, the primary components may be described as being part of a primary sub-system. Components separated from site A 101 may be described as secondary components. Similarly, secondary components may be described together as secondary subsystems.

At site B 102, video system 100 includes video management system 160 (hereinafter referred to as VMS 160). Site A 101 and Site B 102 are connected by network 150. Site A 101 and Site B 102 may be in different parts of a city, in different parts of the world, or may be different floors of the same building. In another example, site A 101 and site B 102 may not represent different physical locations but may represent separate areas only within the computer networking context.

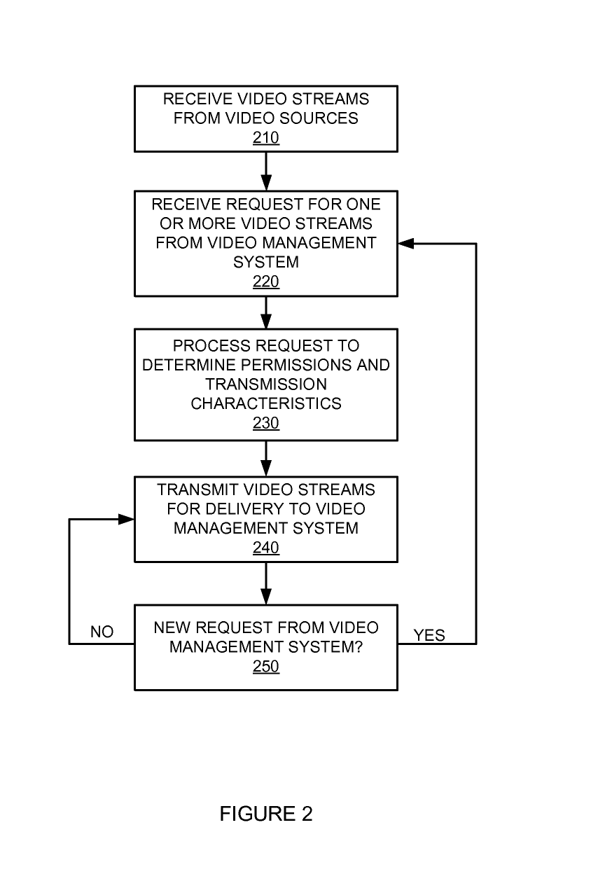

FIG. 2 illustrates an operation of video system 100. The steps of the operation are indicated below and will make simultaneous reference to FIG. 1. As illustrated in FIG. 2, at step 210 VMS 110 receives video streams from video sources 121-124. Simultaneously, media gateway 130 also receives video streams from one or more of video sources 121-124 as part of step 210.

VMS system 160 at site B 102 places a request to receive or more of the video streams at step 220. As part of step 220, media gateway 130 receives the request through network 150. At step 230, media gateway 130 processes the request to determine if VMS 160 is permitted to receive the requested video stream and determines the transmission characteristics.

At step 240, media gateway 130 then transmits the permitted video streams for delivery to VMS 160 at site B 102 over network 150. In at least one example, media gateway 130 transmits the video streams to VMS 160 in a real time, or near real time, without interrupting the video processing and viewing activities taking place in VMS 110. In at least one example, media gateway 130 may modify the video stream before transmitting it to VMS 160 by altering one or more transmission characteristics. Transmission characteristics may include, without limitation, format, resolution, frame rate, compression, color palette, or other characteristics. The bandwidth used to transmit the video streams to VMS 160 may be reduced using these techniques. Media gateway 130 may continue providing these video streams to VMS 160 for a fixed period of time or may continue doing so until a new request or instruction is received from VMS 160 as illustrated at step 250.

Referring back to FIG. 1, video sources 121-124 may include any device(s) configured to capture video and/or images. Further, video sources 121-124 may be configured to transmit video and/or images. As a result, video sources 121-124 may be the devices which perform the initial optical capture of video, may be intermediate video transfer devices, or may be another type of video transmission device. For example, video sources 121-124 may be video cameras, still cameras, internet protocol (IP) cameras, video switches, video buffers, video servers, or other video capture or transmission devices, including combinations thereof.

VMS 110 and VMS 160 may comprise any device for processing and managing video, video streams, or images. VMS 110 and VMS 160 comprise processing circuitry and an interface for receiving video. VMS 110 and VMS 160 are capable of performing one or more processes on the video streams received from video sources 121-124. The processes performed on the video may include viewing, storing, transforming, mathematical computations, modifications, analytical processes, conditioning, other processes, or combinations thereof. VMS 110 and VMS 160 may also comprise additional interfaces for transmitting or receiving video streams, user interface, memory, software, communication components, power supply, or structural support. VMS 110 and VMS 160 may each be a video analytics system, server, computing system, or some other type of processing device, including combinations thereof.

Media gateway 130 comprises any device or combination of devices for converting digital media streams for transmission between two networks. Accordingly, media gateway 130 may include circuitry and interfaces for receiving and sending video streams. For example, media gateway 130 may convert the video stream from video sources 121-124 to a format which can be transmitted over network 150 and received by VMS 160. Media gateway 130 may also include additional interfaces, memory, software, communication components, a power supply, and/or structural support. Media gateway 130 may also contain a media gateway controller or may be controlled by a separate media gateway controller as desired. Media gateway 130 may also support other types of communications in addition to video streams.

In at least one example, media gateway 130 may be configured to stream multiple video streams simultaneously. In particular, multiple media gateways may, in parallel, stream different video streams to a single VMS or each media gateway may stream different video streams to different VMSs.

Network 150 may be any type of communication channel which connects site A 101 and site B 102 and allows media gateway 130 to communicate with VMS 160. For example, network 150 may be an Internet, intranet, dedicated link, wireless link, or some other type of communication link and/or combinations thereof. Network 150 includes a communication medium. The communication medium may be metal, air, space, optical fiber such as glass or plastic, or some other material, including combinations thereof. Network 150 may use various communication protocols, such as TDM, IP, Ethernet, telephony, optical networking, wireless protocols, or some other type of communication signaling or communication format, including combinations thereof. Network 150 may provide a direct link between media gateway 130 and VMS 160 or may provide an indirect link which includes routers, servers, or other types of network communication devices, including combinations thereof.

Generally, a virtual private network (VPN) is often a network that uses public telecommunication infrastructure, such as the Internet, to provide a secure connection for communication between two networks or devices which are otherwise separate. As a result, a VPN may be an alternative to a dedicated leased or owned communication link which is not open to other users. Further, a VPN encapsulates data transfers between the two or more networks or devices to keep the transferred data private from other devices which have access to the networks and equipment used to complete the transfer. In one example of operation, the network 150 may be a trusted VPN as described above. The network 150 configured as a VPN may be a connection that is established between VMS 160 and media gateway 130 over network 150.

In at least one example, media gateway 130 transmits video streams over the network 150 configured as a trusted VPN connection using standard real time streaming protocol (RTSP). RTSP is a network control protocol designed for use in communications systems to control streaming media servers. While various implementations are possible, RTSP over TCP (port 554) is one typical implementation. Using this method, VMS 160 may be able to receive and display the RTSP video stream without having to integrate the protocol of video sources 121-124, without knowing how to decode the protocol, and without having other knowledge of the protocol. In other cases, VMS 160 may utilize the RTSP protocol and the video source format.

In the example above, media gateway 130 may implement a web server in order to provide web services and facilitate access to the video stream from one or more of the video sources 121-124 for VMS 160 or for other devices. Alternately, the web services may be implemented using other devices. In one example, a web services interface is implemented using a simple object access protocol using extensible markup language (SOAP/XML). Such a configuration may allow secondary components/secondary sub-systems or other authorized third party VMSs to access the video streams from selected video sources 121-124.

The video streams from video sources 121-124 may be accessible through a dedicated web address or universal resource locator (URL). In particular, VMS 160 may request access to a particular video stream by submitting a request with the URL for the desired video stream. In other examples, VMS 160 may complete a more extensive login process. One exemplary process may include submitting a password or other credential, requesting a list of available cameras, and requesting video streams from one or more of the available cameras. Such a process may allow the sub-systems to determine when a new camera is available or previously available cameras have become unavailable. In particular, by comparing the list of currently available cameras to a list of previously available cameras, newly available and newly unavailable cameras may be detected. Further, the video data that is streamed from the video management system 110 from available cameras may be based on updated user credentials associated with the request described above.

Media gateway 130 may be configured to provide the video stream in real time, or near real time, regardless of whether that video stream is being accessed by VMS 110 and without interrupting, burdening, or creating a conflict with VMS 110. Once received, VMS 160 may further distribute or multicast the video stream to other devices through one or more commonly known methods.

The determination as to which video streams may be transmitted to VMS 160 may be made manually by a user or automatically as desired. For example, video stream availability may be automatically determined based on any number of parameters, such as the time of day, day of week, a current threat level, content of the video stream as determined through video processing techniques, or based on other factors.

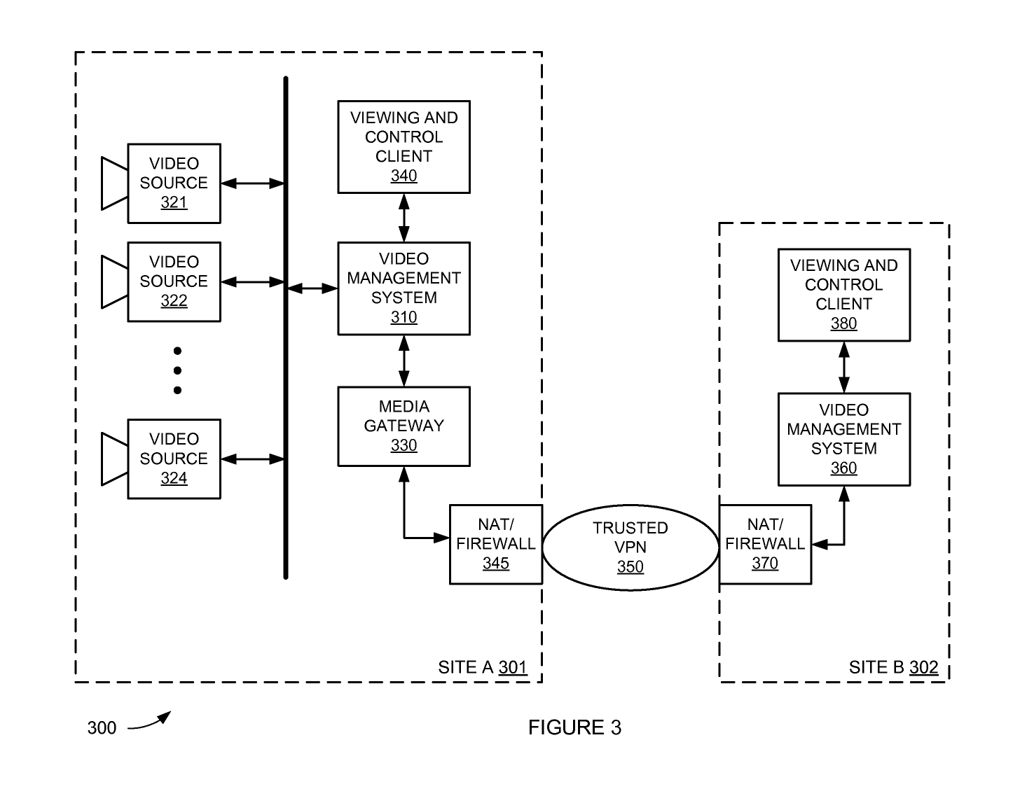

FIG. 3 illustrates video system 300. Video system 300 is spread across two physical locations, site A 301 and site B 302. Similar to the video system 100 (FIG. 1), the components associated with site A 301 may be described as being primary components and grouped as a primary sub-system while the components not associated with site A 301 may be described as secondary components and grouped as secondary sub-systems.

Referring still to FIG. 3, at site A 301, video system 300 comprises video sources 321-324, VMS 310, viewing and control client 340, NAT/firewall 345, and media gateway 330. At site B 302, video system 300 comprises VMS 360, NAT/firewall 370, and viewing and control client 380. Site A 301 and Site B 302 are connected through trusted VPN 350. Site A 301 and Site B 302 may be in different parts of a city, in different parts of the world, or may be different floors of the same building. In another example, site A 301 and site B 302 may not represent different physical locations but may represent separate areas only within the computer networking context.

Video sources 321-324 may be similar to video sources 121-124 (FIG. 1) or video sources 321-324 may be configured differently or operate in alternate manners. VMS 310 and VMS 360 may be configured similarly to VMS 110 and VMS 160 (both shown in FIG. 1) or VMS 310 and VMS 360 may be configured differently or operate in alternate manners. Media gateway 330 may be configured similarly to media gateway 130 or media gateway 330 may be configured differently or operate in an alternate manner. Trusted VPN 350 is one example of a type of connection which may be established on network 150 as introduced above.

NAT/firewall 345 and NAT/firewall 370 are network firewalls which may also provide network address translation (NAT) functionality. As a result, NAT/firewall 345 and/or NAT firewall 370 may block unauthorized access to each of the sites 301, 302 while permitting authorized communications to access the sites 301, 302. The NAT/firewalls 345, 370 may be implemented in hardware, software, or both. As suggested by the labels, NAT/firewalls 345, 370 may be configured to provide NAT functionality. Accordingly, NAT/firewalls 345, 370 may be configured to perform the process of modifying network address information in the headers of packets which are in transit for the purpose of remapping one address space into another. Among other functions, the NAT process protects the actual addresses of devices inside the network from disclosure outside the network.

Viewing and control clients 340 and 380 may be configured to interact with and operate VMS 310 and VMS 360. Viewing and control clients 340 and 380 may comprise software, hardware, or both. Viewing and control clients 340 and 380 may be further configured to select video streams, view video streams, control a VMS, configure the video system, send commands, receive alerts, or for other functions.

In video system 300, media gateway 330 receives video streams from one or more of the video sources 312-324 through VMS 310. VMS 310 receives the video streams associated with video sources 321-324 and makes them available to a user at site A 301 through viewing and control client 340. VMS 310 also makes the video streams available to media gateway 330. In this way, media gateway 330 receives the video streams in a different manner than the media gateway of video system 100. The process through which VMS 360 requests video streams from media gateway 330 and receives video streams from media gateway 330 is otherwise similar to that of video system 100.

In the example shown in FIG. 3, both VMS 360 and VMS 310 are capable of sending control commands to video sources 321-324. These control commands may include instructions to pan, tilt, zoom, power cycle, or execute other functions. The control commands may be generated by the software in VMS 310, VMS 360, or may be generated through user inputs to viewing and control clients 340 and 380.

In this example, VMS 360 is subordinate to VMS 310. As a result, VMS 360 may issue control commands but may only have to permission to issue a subset of the commands VMS 310 is able to issue. In addition, to avoid conflicting instructions, VMS 360 may be prevented from issuing commands to a video source if VMS 310 is issuing commands to or utilizing video from the same video source. In other examples, control of the various video sources may be established by prioritizing users of VMS 310 over users of VMS 360. Similar priorities may be established in other implementations described herein.

In addition, video system 300 may have additional features or modes of operation. For example, VMS 360 may be associated with additional video sources for which it is the primary controller. VMS 360 may be associated with these additional cameras in the same way that VMS 310 is associated with video sources 321-324. VMS 360 may make video streams from these additional cameras available to VMS 310, or other systems, through use of a media gateway in the same manner that VMS 310 made video from video sources 321-324 available. In other words, the operation may be bidirectional in the sense that both systems are making video available to the other system through a media gateway and web services interface using the methods described above. Both systems may also be making the video available to third parties as well.

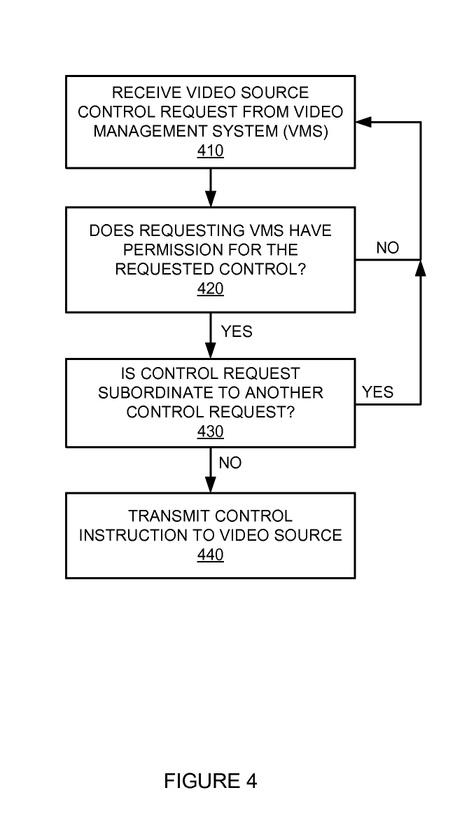

FIG. 4 illustrates operation of a video system in which more than one VMS issues control commands to the video sources. The example of FIG. 4 will be described in the context of video system 300 but could also be implemented in video system 100, video system 500, or in other types of video systems. In the example of FIG. 4.

As illustrated in FIG. 4, operation of the video system 300 includes at step 410 receiving video source control request from VMS 360. A determination is made at step 420 as to whether VMS 360 has permission to control that device. If the VMS 360 does not have permission to control the device, the control request is not executed and the video system 300 continues to monitor for requests from the VMS at step 410. If VMS 360 does have permission to control a given device, at step 430 a determination is made as to whether the request is subordinate to other control activities being performed by VMS 310. If the request is subordinate or would otherwise cause a conflict, the control request is not executed and the video system 300 continues to monitor for requests from the VMS as described above. If the control request is not subordinate, the control instruction is transmitted to the video source at step 440. The steps described in FIG. 4 may be performed by media gateway 330, VMS 310, or some other device.

In this way, a VMS in another network, like VMS 360, may perform permitted control functions on the video sources without causing a conflict with control functions which are being performed by a VMS in the local network. A user of VMS 310 may be able to selectively modify which types of control functions are available to VMS 360. The amount of control available to VMS 360 may automatically be determined based on any number of parameters, such as the time of day, day of week, a current threat level, or content of the video stream as determined through video processing techniques.

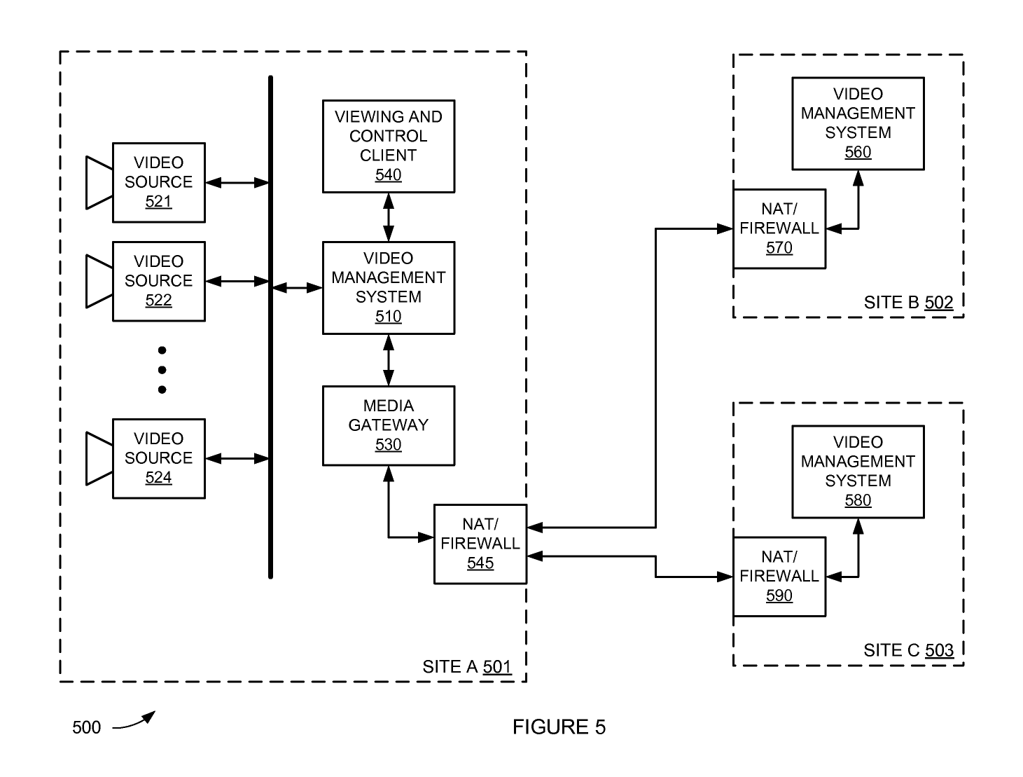

FIG. 5 illustrates an exemplary video system 500. Video system 500 is similar to video system 300 in many respects but includes an additional site, site C 503. Site C 503 is similar to site B 502 but may have different characteristics. In video system 500, VMS 560 and VMS 580 may both receive video streams through media gateway 530 using the same methods described with respect to FIG. 3. VMS 560 and VMS 580 may simultaneously receive the same video stream or may receive different video streams. The connections established between NAT/firewall 545, NAT/firewall 570, and NAT/firewall 590 are established over a network similar to network the connection described above with reference to network 150 (FIG. 1). The connections between the NAT/firewall 545, 570, and/or 590 may also be established as a trusted VPN connection as in FIG. 3 or by other means. In this way, multiple entities at multiple sites may securely and simultaneously receive RTSP video streams over an open network or Internet connection. Different sets of video streams may be available to different sites. Media gateway 530 may use various techniques or criteria to determine which streams are available to which sites.

Each of video systems 100, 300, and 500 provide a secure and non-obtrusive means of allowing multiple VMSs to access and utilize video without creating the conflict of two sub-systems attempting to access or control the same devices. The operator of the primary VMS 510 is able to control access and determine which video is available to the secondary VMSs. Because the access to and distribution of the video to the secondary VMSs is controlled by the media gateway 530, there is minimal effect on the performance of the system 500 at the primary site 501 because each of the secondary VMSs are not attempting to access the cameras or video encoder. Whenever configuration or status changes occur in the primary site A 501 (for example, a new camera being added or a camera being temporarily out of service) this information is automatically updated and indicated in login processes used by the secondary VMSs to gain access to video.

These approaches allow the operator of site A 501 to share video with other parties in a controlled and secure manner. The operator of site A 501 is able to control which cameras can be accessed and allow access to the video from those cameras without hindering the performance of the primary system or allowing the other parties to access the cameras or encoders directly.

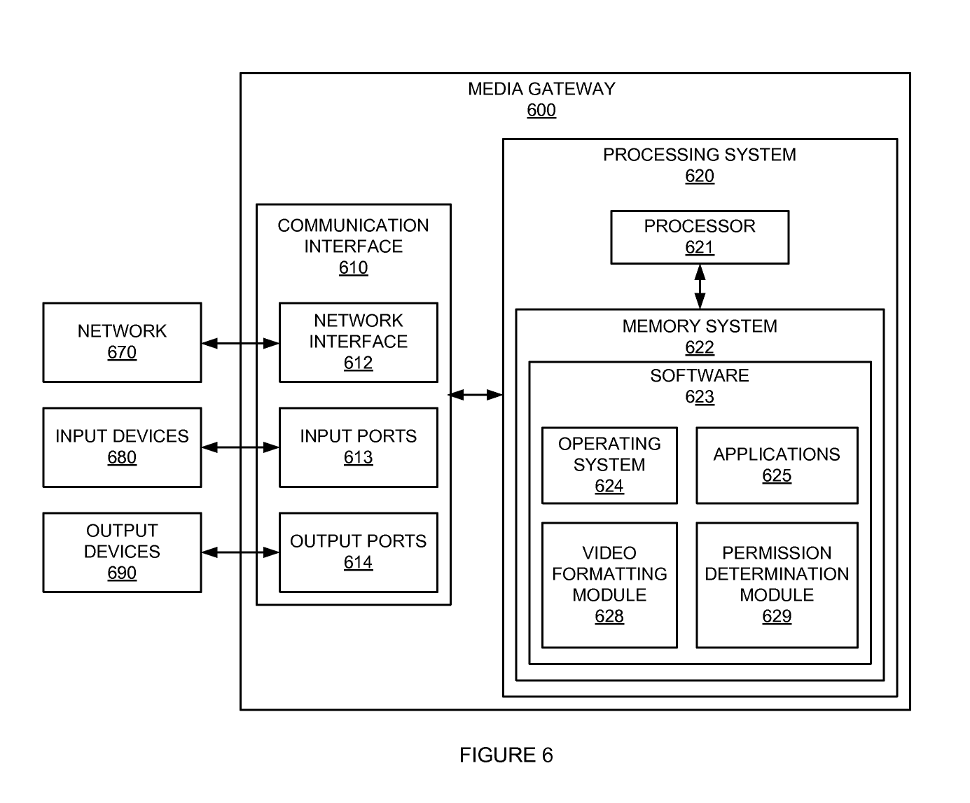

FIG. 6 illustrates an exemplary media gateway 600. Media gateway 600 includes communication interface 610 and processing system 620. It will be appreciated that the media gateway 600 may be implemented to allow remote access to video streams received vie input devices 680 to allow a video management system associated with the media gateway 600 to connect to a remote video management system to provide live or recorded video streams and/or control of the input devices 680. For example, a large organization may have multiple assets in a region. The organization may receive requests, such as from law enforcement agencies, to allow access to some of the strategic video sources pointing to desired locations. This access may allow law enforcement agencies to constantly record and monitor the selected location. In another example, corporate headquarters of a business may monitor security video streams of a remote site. The surveillance system may be implemented at the remote site within the network of the remote site. Local personnel at the remote site may manage the surveillance system and monitor video streams using a local video management system. However, the corporate headquarters may also want the option of remotely accessing and monitoring video streams from the surveillance system using a second, remote video management system. The corporate headquarters may wish to do this over an open network because there is no internal network or dedicated link between the two sites. The video management systems described herein may be utilized to link the two sites.

Though other configurations may be implemented, in FIG. 6, processing system 620 is linked to communication interface 610 through a communication link. Processing system 620 includes processor 621 and memory system 622.

Communication interface 610 includes network interface 612, input ports 613, and output ports 614. Communication interface 610 includes components that communicate over communication links, such as network cards, ports, RF transceivers, processing circuitry and software, or some other communication device. Communication interface 610 may be configured to communicate over metallic, wireless, or optical links. Communication interface 610 may be configured to use TDM, IP, Ethernet, optical networking, wireless protocols, communication signaling, or some other communication format, including combinations thereof. Communication interface 610 may have multiple network interfaces line network interface 612.

Network interface 612 is configured to connect to external devices over network 670. Input ports 613 are configured to connect to input devices 680 such as a video source, keyboard, mouse, viewing and control clients, or other input devices. Output ports 614 are configured to connect to output devices 690 such as a display, a printer, or other output devices.

Processor 621 includes microprocessor and other circuitry that retrieves and executes operating software from memory system 622. Memory system 622 comprises software 623. Memory system 622 may be implemented using random access memory, read only memory, a hard drive, a tape drive, flash memory, optical storage, or other memory apparatus.

Software 623 comprises operating system 624, applications 625, video formatting module 628, and permission determination module 629. Software 623 may also comprise additional computer programs, firmware, or some other form of non-transitory, machine-readable processing instructions. When executed by processor 621, software 623 directs processing system 620 to operate video processing system 600 to process video as described herein. Processing system 620 uses video formatting module 628 to format video streams in RTSP format for transmission to other networks. Processing system 620 also uses permission determination module 629 to determine which video streams a particular VMS may be eligible to receive and to determine whether a VMS is permitted to transmit control instructions to a video source.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. A method of operating a video system to distribute video streams, comprising:
receiving at least one video stream at a primary video management system;
receiving the video stream at a primary media gateway;
receiving a request for access to the video stream from a secondary video management system; and
transmitting the video stream for delivery from the primary media gateway to the secondary video management system.

2. The method of claim 1, wherein receiving the video stream at the primary video management system and receiving the video stream at the primary media gateway occur simultaneously.

3. The method of claim 1, wherein the video stream received at the primary media gateway is transmitted from the primary video management system to the primary media gateway.

4. The method of claim 3, wherein the video management system further transmits the video stream to a viewing and control client.

5. The method of claim 4, further comprising transmitting the video stream from the secondary video management system to a secondary viewing and control client.

6. The method of claim 1, further comprising establishing authorizations for access to the video stream through the primary media gateway, determining if the secondary video management system is authorized to access the video stream based on the authorizations, and responsive to a determination that the secondary video management system is authorized, transmitting the video stream for delivery from the primary media gateway to the secondary video management system.

7. The method of claim 1, wherein the video stream is transmitted over a network.

8. The method of claim 7, wherein the video stream is transmitted over a virtual private network.

9. The method of claim 1, wherein the request includes a uniform resource locator associated with the video stream.

10. The method of claim 1, wherein the primary video management system has primary control over a video source associated with the video stream and wherein the primary media gateway grants secondary control over the video sources associated with the video stream to the secondary video management system based on the request for access to the video stream, the secondary control being subordinate to the primary control.

11. A video system, comprising:
at least one video source;
a primary video management system configured to receive a video stream captured by the video source;
a primary media gateway configured to receive the video stream; and
a secondary video management system configured to generate a request for access to the video stream, wherein the primary media gateway is configured to transmit the video stream for delivery from the primary media gateway to the secondary video management system.

12. The system of claim 11, wherein the primary video management system and the primary media gateway each receive the video stream from the video source.

13. The system of claim 11, wherein the primary media gateway receives the video stream from the video management system.

14. The system of claim 13, further comprising a viewing and control client configured to receive the video stream from the video management system.

15. The system of claim 11, wherein the video stream is transmitted over a network.

16. The system of claim 15, wherein the video stream is transmitted over a virtual private network.

17. The system of claim 15, further comprising a primary NAT/firewall between the primary media gateway and the network and a secondary NAT/firewall between the secondary video management system and the network.

18. The system of claim 11, wherein the primary video management system has primary control over the video source and wherein the primary video management system grants secondary control over the video sources associated with the video stream to the secondary video management system based on the request for access to the video stream, the secondary control being subordinate to the primary control.

19. The system of claim 11, further comprising a plurality of secondary video management systems.

20. A computer readable medium having instructions thereon for controlling a video system that when executed cause the video system to:
receive at least one video stream at a primary video management system;
receive the video stream at a primary media gateway;
receive a request for access to the video stream from a secondary video management system; and
transmit the video stream for delivery from the primary media gateway to the secondary video management system.
